(19) United States
(12) Patent Application Publication
(10) Pub. No.: US 2026/0149016 A1
(43) Pub. Date: May 28, 2026

(54) FUEL CELL SYSTEM

(71) Applicant: TOYOTA BOSHOKU KABUSHIKI KAISHA, Aichi-ken (JP)

(72) Inventors: Kensuke DOI, Obu-shi (JP); Satoshi GOTO, Kasugai-shi (JP)

(73) Assignee: TOYOTA BOSHOKU KABUSHIKI KAISHA, Aichi-ken (JP)

(21) Appl. No.: 19/394,147

(22) Filed: Nov. 19, 2025

(30) Foreign Application Priority Data
Nov. 26, 2024 (JP) 2024-205727

(51) Int. Cl. H01M 8/0444; H01M 8/0438; H01M 8/04791; H01M 8/04828

(52) U.S. Cl. CPC H01M 8/04462; H01M 8/04402; H01M 8/04805; H01M 8/04843

(57) ABSTRACT

A fuel cell system includes a fuel cell that discharges hydrogen off-gas including an unreacted portion of the hydrogen gas together with nitrogen gas and moisture, a hydrogen supply passage; a return passage to return the hydrogen off-gas to the hydrogen supply passage, a gas-liquid separator that is provided on the return passage, obtains dehumidified hydrogen gas by separating the moisture from the hydrogen off-gas, an exhaust valve to discharge the dehumidified hydrogen gas from the return passage, a pressure sensor to detect pressure in the return passage, and a control device that controls the exhaust valve. The control device estimates a concentration of the nitrogen gas included in the dehumidified hydrogen gas based on a detection value of the pressure sensor, and controls the exhaust valve to open when the concentration of the nitrogen gas becomes not less than a predetermined value.

### CROSS-REFERENCE TO RELATED APPLICATIONS

The present patent application claims the priority of Japanese patent application No. 2024/205727 filed on Nov. 26, 2024, and the entire contents of Japanese patent application No. 2024/205727 are hereby incorporated by reference.

### TECHNICAL FIELD

The present invention relates to a fuel cell system in which hydrogen gas is supplied to a fuel cell to generate power.

### BACKGROUND ART

A fuel cell system, which generates power through an electrochemical reaction between hydrogen gas and oxygen gas and supplies the power to electric motors that drive vehicles, etc., has been developed. A general fuel cell system has a fuel cell that includes an anode (fuel electrode) supplied with hydrogen gas fed from a hydrogen gas tank through a hydrogen supply passage and a cathode (oxygen electrode) supplied with air containing oxygen gas, a gas-liquid separator that separates moisture from hydrogen off-gas containing unreacted hydrogen gas and moisture discharged from the fuel cell, and a return passage to return the hydrogen off-gas from which moisture has been separated in the gas-liquid separator, to the hydrogen supply passage by using a pump.

In the fuel cell, as the electrochemical reaction progresses, nitrogen in the air seeps out from the cathode through an electrolyte membrane to the anode. When this causes an increase in the nitrogen partial pressure and a decrease in the hydrogen concentration at the anode, the power generation capacity of the fuel cell decreases. The fuel cell system described in Patent Literature 1 is configured to calculate the amount of impurity gas present based on propagation time of ultrasonic waves in the mixed gas in the hydrogen circulation path, and when the amount of impurity gas present is not less than a predetermined amount, open a purge valve (exhaust valve) to purge (discharge) the impurity gas accumulated in the fuel cell and the hydrogen circulation path.

Patent Literature 1: JP 2003/317752A

### SUMMARY OF INVENTION

In the fuel cell system described in Patent Literature 1, since purging is performed when the amount of impurity gas present becomes not less than a predetermined amount, it is possible to discharge the impurity gas more efficiently than when, e.g., periodically purging at predetermined time intervals. However, the fuel cell system described in Patent Literature 1 has a problem that an ultrasonic transceiver is required, which increases costs.

It is an object of the invention to provide a fuel cell system that is capable of estimating a nitrogen concentration in gas discharged from a fuel cell at low cost.

An aspect of the invention provides a fuel cell system, comprising:
a fuel cell that generates power through an electrochemical reaction between hydrogen gas and oxygen gas, and discharges hydrogen off-gas comprising an unreacted portion of the hydrogen gas together with nitrogen gas and moisture;
a hydrogen supply passage to supply the hydrogen gas from a hydrogen supply source to the fuel cell;
a return passage to return the hydrogen off-gas to the hydrogen supply passage;
a gas-liquid separator that is provided on the return passage, obtains dehumidified hydrogen gas by separating the moisture from the hydrogen off-gas, and stores the separated moisture;
an exhaust valve to discharge the dehumidified hydrogen gas from the return passage;
a pressure sensor to detect pressure in the return passage; and
a control device that controls the exhaust valve,
wherein no pump to pump out the dehumidified hydrogen gas is arranged on the return passage, and
wherein the control device estimates a concentration of the nitrogen gas included in the dehumidified hydrogen gas based on a detection value of the pressure sensor, and controls the exhaust valve to open when the concentration of the nitrogen gas becomes not less than a predetermined value.

### Advantageous Effects of Invention

According to an embodiment of the invention, a fuel cell system can be provided by which a nitrogen concentration in gas discharged from a fuel cell can be estimated at low cost.

### BRIEF DESCRIPTION OF DRAWINGS

FIG. 1 is a schematic configuration diagram illustrating an example configuration of a fuel cell system in an embodiment of the present invention.

FIG. 2 is a graph showing an example of changes in a concentration of nitrogen gas (estimated value) in dehumidified hydrogen gas and the open/close state of an exhaust valve.

FIG. 3 is a schematic configuration diagram illustrating an example configuration of a fuel cell system in Comparative Example.

### DESCRIPTION OF EMBODIMENTS3

### Embodiment

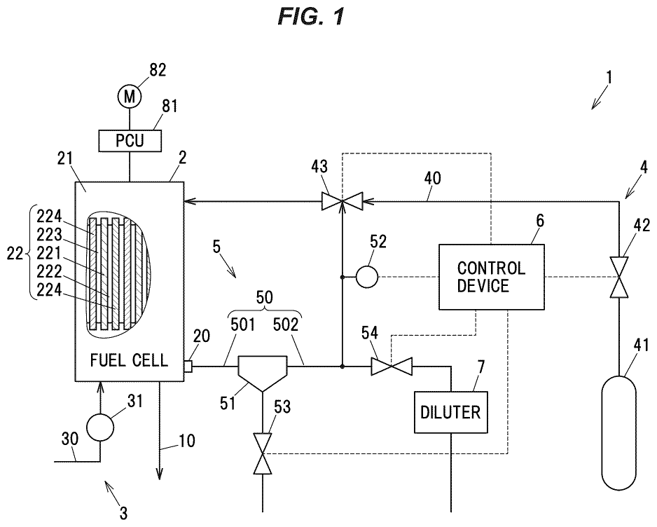

FIG. 1 is a schematic configuration diagram illustrating an example configuration of a fuel cell system 1 in an embodiment of the invention. This fuel cell system 1 is installed in, e.g., an electric-powered small mobility vehicle having an electric motor as a driving source, and generates power to be supplied to the electric motor. Here, the electric-powered small mobility vehicle refers to a vehicle that is lighter in total weight than standard vehicle and light vehicle under the Road Transport Vehicle Act of Japan and is powered by an electric motor. Specific examples of the electric-powered small mobility vehicle include golf cart, electrically assisted bicycle, electric kick scooter, and mobility scooter, etc.

The fuel cell system 1 includes a fuel cell 2, an air supply system 3 that supplies air including oxygen gas to the fuel cell 2, a hydrogen supply system 4 that supplies hydrogen gas as fuel to the fuel cell 2, a hydrogen return system 5 that recovers an unreacted portion of the hydrogen gas discharged from the fuel cell 2 and returns it to the hydrogen supply system 4, a control device 6, and a diluter 7. Power generated by the fuel cell 2 is converted by a PCU (Power Control Unit) 81 including a capacitor, a DC-DC converter and an inverter, and is supplied to an electric motor 82 which is a driving source of the small mobility vehicle, etc.

The fuel cell 2 has a stacked structure in which plural unit cells 22 are stacked inside a case 21. In FIG. 1, a part of the case 21 is cut away to show the inside thereof. Each unit cell 22 includes a flat electrolyte membrane 221, an anode (fuel electrode) 222 provided on a surface of the electrolyte membrane 221 on one side in the stacking direction, a cathode (oxygen electrode) 223 provided on a surface of the electrolyte membrane 221 on the other side in the stacking direction, and a pair of separators 224 arranged opposite each other with the anode 222 and the cathode 223 interposed therebetween.

In each unit cell 22 constituting the fuel cell 2, when the hydrogen gas as a fuel gas is supplied to the anode 222 and the oxygen gas is supplied to the cathode 223, power is generated through an electrochemical reaction between the hydrogen gas and the oxygen gas. In addition, in the fuel cell 2, as the electrochemical reaction progresses, a portion of nitrogen in the air seeps out from the cathode 223 to the anode 222 side through the electrolyte membrane 221. From a discharge port 20, the fuel cell 2 discharges hydrogen off-gas which includes the unreacted hydrogen gas that did not undergo the electrochemical reaction with the oxygen gas, moisture produced during power generation of the fuel cell 2, and nitrogen gas which has seeped out to the anode 222 side.

The air supply system 3 includes an air supply passage 30 through which the air supplied to the fuel cell 2 flows, and a compressor 31 provided on the air supply passage 30. Oxygen off-gas discharged from the fuel cell 2 is discharged through an air exhaust passage 10. The air supplied to the fuel cell 2 is the ambient air around the fuel cell system 1, and includes about 21% oxygen and about 78% nitrogen.

The hydrogen supply system 4 has a hydrogen supply passage 40 to supply the hydrogen gas from a hydrogen tank 41 as a hydrogen supply source to the fuel cell 2, a main stop valve 42 that is an electromagnetic valve to block or allow supply of the hydrogen gas from the hydrogen tank 41 to the fuel cell 2, and an ejector 43 that adjusts the amount of the hydrogen gas supplied to the fuel cell 2. The main stop valve 42 and the ejector 43 are provided on the hydrogen supply passage 40. A pressure reducing valve may additionally be provided between the main stop valve 42 and the ejector 43.

The ejector 43 is arranged on the hydrogen supply passage 40 between the main stop valve 42 and the fuel cell 2, and ejects the hydrogen gas from the hydrogen tank 41 toward the fuel cell 2. The amount of the hydrogen gas supplied to the fuel cell 2 through the ejector 43 is controlled by the control device 6. The ejector 43 has a valve that opens and closes in response to a pulse signal output from the control device 6. When the cycle of the pulse signal output from the control device 6 to the ejector 43 becomes short, after the valve opens, the valve closes before the flow rate of the hydrogen gas in the hydrogen supply passage 40 increases, resulting in a decrease in the amount of the hydrogen gas supplied to fuel cell 2. On the other hand, when the cycle of the pulse signal becomes long, the flow rate of the hydrogen gas in the hydrogen supply passage 40 increases, resulting in an increase in the amount of the hydrogen gas supplied to fuel cell 2. The control device 6 controls the ejector 43 using the cycle of the pulse signal so that the hydrogen gas in an amount corresponding to the required amount of power generation by the fuel cell 2 is supplied to the fuel cell 2.

The hydrogen return system 5 has a return passage 50 to return the hydrogen off-gas discharged from the fuel cell 2 to the hydrogen supply passage 40, a gas-liquid separator 51 provided in the middle of the return passage 50, a pressure sensor 52 to detect pressure in the return passage 50, a drain valve 53 connected to the gas-liquid separator 51, and an exhaust valve 54 connected to the return passage 50.

The gas-liquid separator 51 obtains dehumidified hydrogen gas by separating moisture from the hydrogen off-gas. The return passage 50 returns the dehumidified hydrogen gas, from which the moisture has been separated in the gas-liquid separator 51, to the hydrogen supply passage 40. The moisture separated in the gas-liquid separator 51 is temporarily stored in the gas-liquid separator 51 in the form of liquid, and is discharged to the outside when the drain valve 53 is opened. The exhaust valve 54 is connected to the return passage 50 on the downstream side relative to the gas-liquid separator 51 and discharges the dehumidified hydrogen gas in the return passage 50 toward the diluter 7. The diluter 7 dilutes the dehumidified hydrogen gas to a hydrogen concentration not causing a safety problem even if discharged into the atmosphere, and releases the diluted exhaust gas into the atmosphere.

Hereinafter, a portion of the return passage 50 on the upstream side relative to the gas-liquid separator 51 will be referred to as a first return passage 501, and a portion of the return passage 50 on the downstream side relative to the gas-liquid separator 51 will be referred to as a second return passage 502. The pressure sensor 52 is connected to the second return passage 502, detects pressure of the dehumidified hydrogen gas in the second return passage 502, and outputs the detection result to the control device 6.

The return passage 50 is connected to the ejector 43. The return passage 50 does not have a pump to pump out the dehumidified hydrogen gas, and the ejector 43 adds the dehumidified hydrogen gas from the second return passage 502 to the hydrogen gas supplied from the hydrogen tank 41 through the hydrogen supply flow path 40 and ejects it toward the fuel cell 2. In more particular, the ejector 43 draws in the dehumidified hydrogen gas from the return passage 50 by negative pressure generated when ejecting the hydrogen gas from the hydrogen tank 41 toward the fuel cell 2, and ejects the drawn-in dehumidified hydrogen gas, together with the hydrogen gas from the hydrogen tank 41, to the fuel cell 2.

The open/close states of the drain valve 53 and the exhaust valve 54 are controlled by the control device 6. The control device 6 estimates a concentration of the nitrogen gas included in the dehumidified hydrogen gas based on a detection value of the pressure sensor 52, and controls the drain valve 53 and the exhaust valve 54 to stay open for a predetermined period of time when the estimated concentration of the nitrogen gas becomes not less than a predetermined value. As a result, the nitrogen concentration at the anode 222 of the fuel cell 2 decreases and the power generation capacity of the fuel cell 2 is maintained. That is, the power generation capacity of the fuel cell 2 decreases if an increase in the concentration of the nitrogen gas and a decrease in the concentration of the hydrogen gas occur at the anode 222 of the fuel cell 2. However, in the present embodiment, when the concentration of the nitrogen gas estimated based on the detection value of the pressure sensor 52 becomes not less than a predetermined value, the exhaust valve 54 is controlled to open and the nitrogen partial pressure at the anode 222 decreases, hence, the power generation efficiency of the fuel cell 2 is enhanced.

Here, a method for estimating the concentration of the nitrogen gas in the dehumidified hydrogen gas based on the detection value of the pressure sensor 52 will be described. The molecular weight of the hydrogen gas (H₂) is 2.0158 g/mol, while the molecular weight of the nitrogen gas (N₂) is 28.0134 g/mol. For this reason, the nitrogen gas has a higher viscosity than the hydrogen gas, hence, the higher the concentration of the nitrogen gas in the dehumidified hydrogen gas, the higher the viscosity of the dehumidified hydrogen gas and the higher the pressure detected by the pressure sensor 52. Thus, it is possible to estimate the concentration of the nitrogen gas in the dehumidified hydrogen gas based on the detection value of the pressure sensor 52.

The control device 6 may estimate the concentration of the nitrogen gas in the dehumidified hydrogen gas also by taking into account influencing factors that affect the pressure detected by the pressure sensor 52. Examples of such influencing factors include the control amount of the ejector 43 by the control device 6 and the power generation amount of the fuel cell 2. In the present embodiment, the cycle of the pulse signal output to the ejector 43 corresponds to the control amount of the ejector 43 by the control device 6. By taking these influencing factors into account when estimating the concentration of the nitrogen gas in the dehumidified hydrogen gas, it is possible to estimate the concentration of the nitrogen gas more accurately.

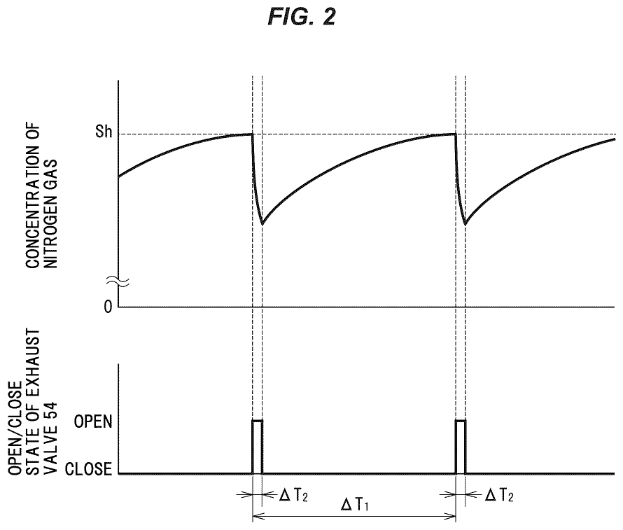

FIG. 2 is a graph showing an example of changes in the concentration of the nitrogen gas (estimated value) in the dehumidified hydrogen gas and the open/close state of the exhaust valve 54. The horizontal axis of the graph is the time axis, and Sh on the vertical axis representing the concentration of the nitrogen gas in the graph indicates the above-mentioned predetermined value.

When the exhaust valve 54 is closed, the concentration of the nitrogen gas in the dehumidified hydrogen gas gradually increases due to nitrogen permeating from the cathode 223 to the anode 222 through the electrolyte membrane 221. When the exhaust valve 54 is opened, the concentration of the nitrogen gas in the fuel cell 2 on the anode 222 side and in the return passage 50 decreases since the dehumidified hydrogen gas with a high concentration of the nitrogen gas is discharged and new hydrogen gas is supplied from the hydrogen tank 41. The power generation capacity of the fuel cell 2 is thereby maintained. The interval (T₁) of time at which the exhaust valve 54 opens is, e.g., about 30 seconds although depending on the amount of power generated by the fuel cell 2, and the time (T₂) during which the exhaust valve 54 is open is, e.g., not more than 1 second.

### Comparative Example

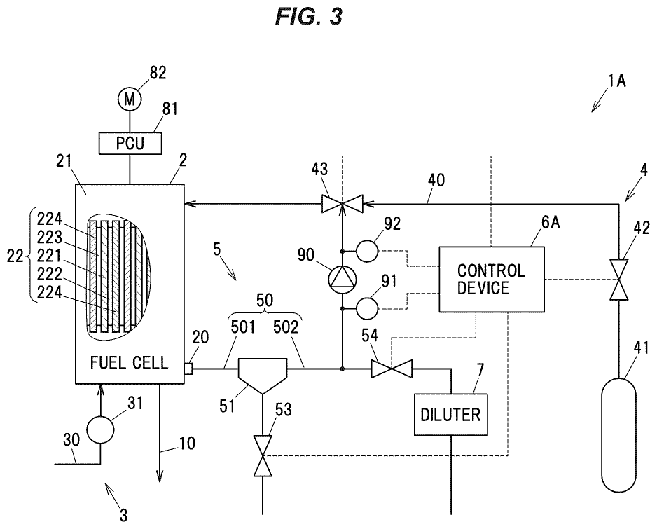

FIG. 3 is a schematic configuration diagram illustrating an example configuration of a fuel cell system 1A in Comparative Example. In FIG. 3, the same components as those of the fuel cell system 1 shown in FIG. 1 are denoted by the same reference signs, and overlapping explanation will be omitted.

The fuel cell system 1A has a pump 90 and a first pressure sensor 91 and a second pressure sensor 92, in place of the pressure sensor 52 of the fuel cell system 1 in the above embodiment. The pump 90 is provided on the second return passage 502 and supplies the dehumidified hydrogen gas to the hydrogen supply passage 40. The first pressure sensor 91 is provided on the gas-liquid separator 51 side relative to the pump 90, and the second pressure sensor 92 is provided on the hydrogen supply passage 40 side relative to the pump 90.

The first pressure sensor 91 and the second pressure sensor 92 detect the pressure of the dehumidified hydrogen gas before and after the pump 90, and output the detection results to a control device 6A. The control device 6A controls the drain valve 53 and the exhaust valve 54 to stay open for a predetermined period of time when the estimated value of the concentration of the nitrogen gas in the dehumidified hydrogen gas becomes not less than the predetermined value in the same manner as the control device 6 of the fuel cell system 1 in the above embodiment, but the control device 6A uses a different method of estimating the concentration of the nitrogen gas from that of the control device 6 in the above embodiment and estimates the concentration of the nitrogen gas based on a difference between the pressure detected by the first pressure sensor 91 and the pressure detected by the second pressure sensor 92.

That is, the viscosity of the dehumidified hydrogen gas increases with an increase in the concentration of the nitrogen gas as described above. Therefore, even if the rotation speed of the pump 90 remains the same, the pressure difference between the suction side and the discharge side of the pump 90 changes when the concentration of the nitrogen gas changes. The control device 6A obtains this pressure difference from the detection results of the first pressure sensor 91 and the second pressure sensor 92, and estimates the concentration of the nitrogen gas in the dehumidified hydrogen gas.

In this fuel cell system 1A, the power generation capacity of the fuel cell 2 can be maintained by controlling the exhaust valve 54 to stay open for a predetermined period of time when the estimated value of the concentration of the nitrogen gas in the dehumidified hydrogen gas becomes not less than the predetermined value in the same manner as the fuel cell system 1 in the above embodiment, but since the pump 90 and two pressure sensors (the first pressure sensor 91 and the second pressure sensor 92) are required, the weight, cost, and power consumption are higher than the fuel cell system 1 in the above embodiment.

In other words, with the fuel cell system 1 of the above embodiment, the nitrogen concentration in the gas discharged from the fuel cell 2 can be estimated at low cost and the weight and power consumption can also be kept down. In addition, since no pump is arranged on the return passage 50, the nitrogen concentration can be accurately estimated based on the detection result of the pressure sensor 52 without being affected by pressure changes caused by the pump.

### Additional Note

Although the invention has been described based on the embodiment, the invention according to claims is not to be limited thereto. Further, please note that not all combinations of the features described in the embodiment are necessary to solve the problem of the invention

In addition, the invention can be appropriately modified and implemented by omitting some components or adding or substituting the components without departing the gist thereof. For example, although the example in which the pressure in the second return passage 502 is detected by the pressure sensor 52 has been described in the above embodiment, the position of the pressure sensor 52 may be changed so that the pressure in the first return passage 501 is detected by the pressure sensor 52. In this regard, however, in the case where the pressure in the second return passage 502 is detected by the pressure sensor 52, it is possible to detect the pressure of the dehumidified hydrogen gas resulting from separating the moisture from the hydrogen off-gas by the gas-liquid separator 51, hence, the nitrogen concentration can be estimated more accurately while suppressing the effect of the moisture.

### REFERENCE SIGNS LIST

1 FUEL CELL SYSTEM
2 FUEL CELL
40 HYDROGEN SUPPLY PASSAGE
43 EJECTOR
50 RETURN PASSAGE
51 GAS-LIQUID SEPARATOR
52 PRESSURE SENSOR
54 EXHAUST VALVE

1. A fuel cell system, comprising:
a fuel cell that generates power through an electrochemical reaction between hydrogen gas and oxygen gas, and discharges hydrogen off-gas comprising an unreacted portion of the hydrogen gas together with nitrogen gas and moisture;
a hydrogen supply passage to supply the hydrogen gas from a hydrogen supply source to the fuel cell;
a return passage to return the hydrogen off-gas to the hydrogen supply passage;
a gas-liquid separator that is provided on the return passage, obtains dehumidified hydrogen gas by separating the moisture from the hydrogen off-gas, and stores the separated moisture;
an exhaust valve to discharge the dehumidified hydrogen gas from the return passage;
a pressure sensor to detect pressure in the return passage; and
a control device that controls the exhaust valve,
wherein no pump to pump out the dehumidified hydrogen gas is arranged on the return passage, and
wherein the control device estimates a concentration of the nitrogen gas included in the dehumidified hydrogen gas based on a detection value of the pressure sensor, and controls the exhaust valve to open when the concentration of the nitrogen gas becomes not less than a predetermined value.

2. The fuel cell system according to claim 1, wherein the pressure sensor is provided on the return passage on a downstream side relative to the gas-liquid separator, and detects pressure of the dehumidified hydrogen gas.

3. The fuel cell system according to claim 1, wherein an ejector to eject the hydrogen gas from the hydrogen supply source toward the fuel cell is arranged on the hydrogen supply passage, wherein the return passage is connected to the ejector, and wherein the ejector adds the dehumidified hydrogen gas from the return passage to the hydrogen gas supplied from the hydrogen supply source through the hydrogen supply passage, and ejects a resulting mixture toward the fuel cell.

4. The fuel cell system according to claim 2, wherein an ejector to eject the hydrogen gas from the hydrogen supply source toward the fuel cell is arranged on the hydrogen supply passage, wherein the return passage is connected to the ejector, and wherein the ejector adds the dehumidified hydrogen gas from the return passage to the hydrogen gas supplied from the hydrogen supply source through the hydrogen supply passage, and ejects a resulting mixture toward the fuel cell.
